(19) United States
(12) Patent Application Publication
(10) Pub. No.: US 2009/0182544 A1
(43) Pub. Date: Jul. 16, 2009

(54) MULTIPLE CHASSIS EMULATION ENVIRONMENT

(76) Inventors: ERIC DURAND, La Ville Du Bois (FR); Estelle Reymond, Orsay (FR); John Fadel, Les Ulis (FR)

Correspondence Address: KLARQUIST SPARKMAN, LLP, 121 S.W. SALMON STREET, SUITE 1600, PORTLAND, OR, 97204, US

(21) Appl. No.: 12/014,698

(22) Filed: Jan. 15, 2008

(51) Int. Cl. G06G 7/48

(52) U.S. Cl. 703/14

(57) ABSTRACT

A method and system is disclosed for a multi-chassis emulator. A user can select between chassis and view additional information about the chassis of interest. In one embodiment, once the user selects a chassis, further information about the chassis can be displayed, such as through folders and files. The user can then navigate through the folders to the desired information for display. In yet another embodiment, after the user has selected a chassis of interest, the user can select particular boards in that chassis and view physical information about the board of interest, such as which ICs on the board are faulty.

### FIELD

The present disclosure generally relates to hardware emulators, and more particularly to a multiple chassis hardware emulator.

### BACKGROUND

Today's sophisticated SoC (System on Chip) designs are rapidly evolving and nearly doubling in size with each generation. Indeed, complex designs have nearly exceeded 50 million gates. This complexity, combined with the use of devices in industrial and mission-critical products, has made complete design verification an essential element in the semiconductor development cycle. Ultimately, this means that every chip designer, system integrator, and application software developer must focus on design verification.

Hardware emulation provides an effective way to increase verification productivity, speed up time-to-market, and deliver greater confidence in the final SoC product. Even though individual intellectual property blocks can be exhaustively verified, previously undetected problems appear when the blocks are integrated within the system. Comprehensive system-level verification, as provided by hardware emulation, tests overall system functionality, IP subsystem integrity, specification errors, block-to-block interfaces, boundary cases, and asynchronous clock domain crossings. Although design reuse, intellectual property, and high-performance tools all help by shortening SoC design time, they do not diminish the system verification bottleneck, which consumes 60-70% of the design cycle. As a result, designers can implement a number of system verification strategies in a complementary methodology including software simulation, simulation acceleration, hardware emulation, and rapid prototyping. But, for system-level verification, hardware emulation remains a favorable choice due to superior performance, visibility, flexibility, and accuracy.

A short history of hardware emulation is useful for understanding the emulation environment. Initially, software programs would read a circuit design file and simulate the electrical performance of the circuit very slowly. To speed up the process, special computers were designed to run simulators as fast as possible. IBM's Yorktown “simulator” was the earliest (1982) successful example of this—it used multiple processors running in parallel to run the simulation. Each processor was programmed to mimic a logical operation of the circuit for each cycle and can be reprogrammed in subsequent cycles to mimic a different logical operation. This hardware ‘simulator’ was faster than the current software simulators, but far slower than the end-product ICs. When Field Programmable Gate Arrays (FPGAs) became available in the mid-80's, circuit designers conceived of networking hundreds of FPGAs together in order to map their circuit design onto the FPGAs and the entire FPGA network would mimic, or emulate, the entire circuit. In the early 90's the term “emulation” was used to distinguish reprogrammable hardware that took the form of the design under test (DUT) versus a general purpose computer (or work station) running a software simulation program.

Soon, variations appeared. Custom FPGAs were designed for hardware emulation that included on-chip memory (for DUT memory as well as for debugging), special routing for outputting internal signals, and for efficient networking between logic elements. Another variation used custom IC chips with networked single bit processors (so-called processor based emulation) that processed in parallel and usually assumed a different logic function every cycle.

Physically, a hardware emulator resembles a large server. Racks of large printed circuit boards are connected by backplanes in ways that most facilitate a particular network configuration. A workstation connects to the hardware emulator for control, input, and output.

Before the emulator can emulate a DUT, the DUT design must be compiled. That is, the DUT's logic must be converted (synthesized) into code that can program the hardware emulator's logic elements (whether they be processors or FPGAs). Also, the DUT's interconnections must be synthesized into a suitable network that can be programmed into the hardware emulator. The compilation is highly emulator specific and can be time consuming.

There are many different physical parameters associated with an emulator environment, such as which board types are plugged into the emulator and where they are plugged in, what are the temperatures on the boards, what are the board failure rates, etc. Prior to compiling a design and trying to run it in an emulator, such physical parameters are helpful to have an understanding if the emulator can accept and emulate the design. Yet, there is not a known way to view such physical parameters in an effective manner. Additionally, there is no desirable way to extend the emulator should the design exceed the capacity of the emulator.

### SUMMARY

The present disclosure provides a method and system for a multi-chassis emulator. A user can select between chassis and view additional information about the chassis of interest.

In one embodiment, once the user selects a chassis, further information about the chassis can be displayed, such as through a folder and file system. The user can then navigate through the folders and files to the desired information for display.

In yet another embodiment, after the user has selected a chassis of interest, the user can select one or more particular boards in that chassis and view physical information about the board of interest, such as which ICs on the board are faulty, temperature of the boards, etc.

In another embodiment, the emulator can easily be extended by adding additional chassis. An emulator server can be added for each chassis making the emulator easily extendable for larger or multiple designs.

These features and others of the described embodiments will be more readily apparent from the following detailed description, which proceeds with reference to the accompanying drawings.

### BRIEF DESCRIPTION OF THE DRAWINGS

FIG. 1 is a system diagram of a hardware emulator environment.

FIG. 2 is a more detailed system diagram showing a host computer coupled to the emulator through an intermediate platform maintenance board.

FIG. 3 is a high-level system diagram of an embodiment showing various servers connected through a messaging bus to multiple emulator chassis, with each server being connected to an associated chassis in this example.

FIG. 4 is a view of an embodiment of a user interface wherein the user can select one of multiple chassis.

FIG. 5 is a three-dimensional physical view of a system of FIG. 1.

FIGS. 6A-6C show an embodiment of a GUI with different physical views of the system.

FIGS. 7A and 7B show an embodiment of the GUI displaying error rates of various boards in the system.

FIGS. 8A-8D show an embodiment of power and temperature information associated with the system using a GUI.

FIGS. 9A and 9B show an embodiment of a logical representation of an internal portion of an IC and a physical view of a printed circuit board using the GUI.

FIGS. 10A and 10B show an embodiment of particular registers of the system accessed through the GUI.

FIG. 11 is an embodiment of a flowchart of a method for displaying multiple chassis and receiving selection information regarding a particular chassis to view.

FIG. 12 is an embodiment showing a user interface display having a file and folder system for viewing information about the chassis.

FIG. 13 is an embodiment of a user interface for selecting a desired emulator.

FIG. 14 is an embodiment of a user interface for showing the available chassis for a selected emulator.

FIG. 15 is an embodiment of a user interface showing a first chassis selected and being powered on in response to the selection.

FIG. 16 is an embodiment of a user interface showing a second chassis selected and being powered on in response to the selection with the first chassis powered on and active.

FIG. 17 is an embodiment of a user interface showing both chassis powered on and active.

FIG. 18 is a flowchart of an embodiment of a method for adding multiple chassis to an emulator.

### DETAILED DESCRIPTION

Disclosed below are representative embodiments of electronic circuit testing techniques and associated apparatus that should not be construed as limiting in any way. Instead, the present disclosure is directed toward all novel and nonobvious features and aspects of the various disclosed methods, apparatus, and equivalents thereof, alone and in various combinations and subcombinations with one another. The disclosed technology is not limited to any specific aspect or feature, or combination thereof, nor do the disclosed methods and apparatus require that any one or more specific advantages be present or problems be solved.

As used in this application and in the claims, the singular forms “a,” “an” and “the” include the plural forms unless the context clearly dictates otherwise. Additionally, the term “includes” means “comprises.” Moreover, unless the context dictates otherwise, the term “coupled” means electrically or electromagnetically connected or linked and includes both direct connections or direct links and indirect connections or indirect links through one or more intermediate elements.

Although the operations of some of the disclosed methods and apparatus are described in a particular, sequential order for convenient presentation, it should be understood that this manner of description encompasses rearrangement, unless a particular ordering is required by specific language set forth below. For example, operations described sequentially can in some cases be rearranged or performed concurrently. Moreover, for the sake of simplicity, the attached figures do not show the various ways in which the disclosed methods and apparatus can be used in conjunction with other methods and apparatus.

Any of the methods described herein can be performed (at least in part) using software comprising computer-executable instructions stored on one or more computer-readable media. Furthermore, any intermediate or final results of the disclosed methods can be stored on one or more computer-readable media. For example, a software tool can be used to determine and store one or more control signals used to control any of the disclosed apparatus. Any such software can be executed on a single computer or on a networked computer (for example, via the Internet, a wide-area network, a local-area network, a client-server network, or other such network). For clarity, only certain selected aspects of the software-based implementations are described. Other details that are well known in the art are omitted. For the same reason, computer hardware is not described in further detail. It should be understood that the disclosed technology is not limited to any specific computer language, program, or computer. For instance, a wide variety of commercially available computer languages, programs, and computers can be used.

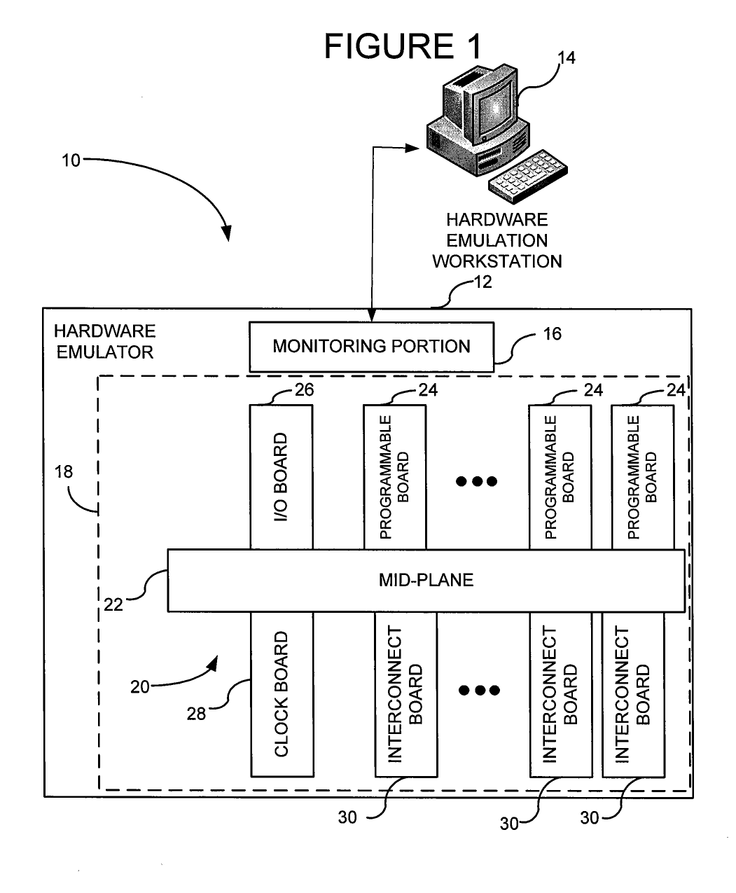

FIG. 1 shows an embodiment of an emulator environment 10 including a single chassis hardware emulator 12 coupled to one or more hardware emulator hosts 14. The emulator host 14 can be any desired type of computer hardware and generally includes a user interface through which a user can load, compile and download a design to the emulator 12. Additionally, the user can select an emulator chassis (not shown) and visualize physical parameters associated with the emulator chassis through a graphical user interface (GUI), as further described below.

The emulator 12 includes a monitoring portion 16 and an emulation portion 18. The emulation portion 18 includes multiple printed circuit boards 20 coupled to a midplane 22. The midplane 22 allows physical connection of the printed circuit boards into the emulator 12 on both sides of the midplane. A backplane can also be used in place of the midplane, the backplane allowing connection of printed circuit boards on one side of the backplane. Any desired type of printed circuit boards can be used. For example, programmable boards 24 generally include an array of FPGAs, VLSIs or ICs, or other programmable circuitry, that can be programmed with the user's design downloaded from the emulator host 14. One or more I/O board interfaces 26 allow communication between the emulator 12 and hardware external to the emulator. For example, the user can have a preexisting processor board that is used in conjunction with the emulator and such a processor board connects to the emulator through I/O board interface 26. Clock board 28 generates any number of desired clock signals. The interconnect boards 30 can allow integrated circuits on the programmable boards 24 to communicate together and with integrated circuits on the I/O board interface 26. Any combination of the above-mentioned boards may be used and any boards may be omitted.

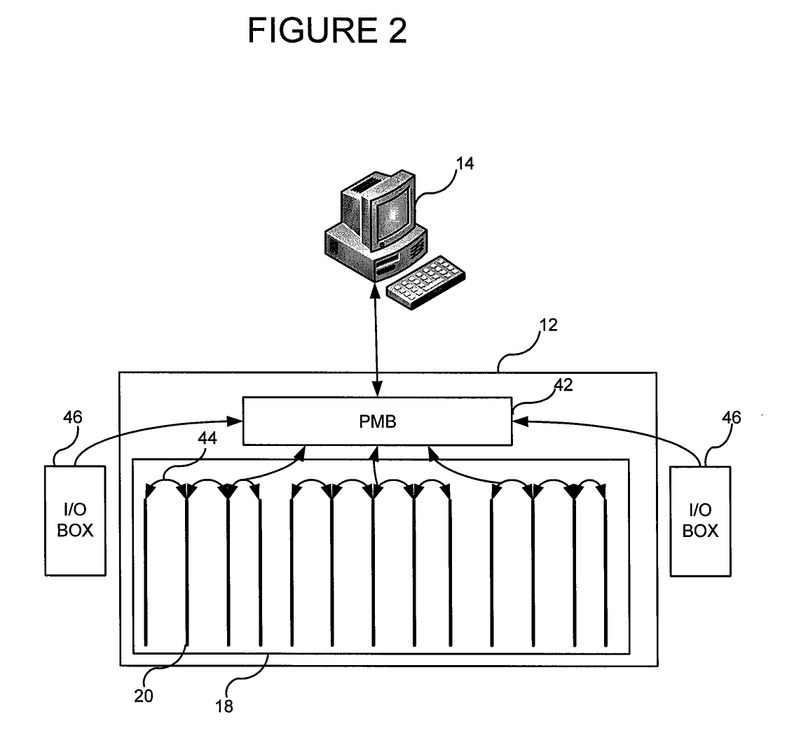

FIG. 2 shows a more detailed view of the system. The host computer 14 can be equipped with a high-speed-link PCI board coupled to a platform maintenance board (PMB) 42, which can act as the monitoring portion 16. The PMB 42 can monitor various physical parameters in the emulator portion 18 and can create the interface between the emulator portion 18 and the one or more host computers 14. The PMB 42 can, on a periodic basis (e.g., 10 seconds), transmit communication and monitoring reports to the host workstation 14 for display in the GUI. Similarly, the PMB 42 can receive information regarding the physical parameters of the emulator portion 18, such as periodically. For example, hardware (e.g., an FPGA) on each printed circuit board 20 can have intelligence for monitoring physical parameters on its respective board and for sending this physical information to the PMB (e.g., every 5 seconds). Other changes, such as a detected error, can be transmitted immediately upon and in response to the detection. Thus, the PMB 42 can in one embodiment instantaneously (as opposed to periodically) detect any changes in the emulation environment 10 and generate real-time state change messages to the host station 14. All of the physical parameters obtained through the PMB can be obtained while the emulator portion 18 is performing emulation. Thus, several emulations can be separately running and the physical parameters of the emulator can separately be viewed on the GUI of the host computers. However, there need not be a link between the number of simultaneous emulations and the number of workstations. For example, many emulations can be simultaneously run through one workstation. IO boxes 46 allow connection of other user boards to the system. The IO boxes 46 are also coupled to the PMB 42 and monitored thereby.

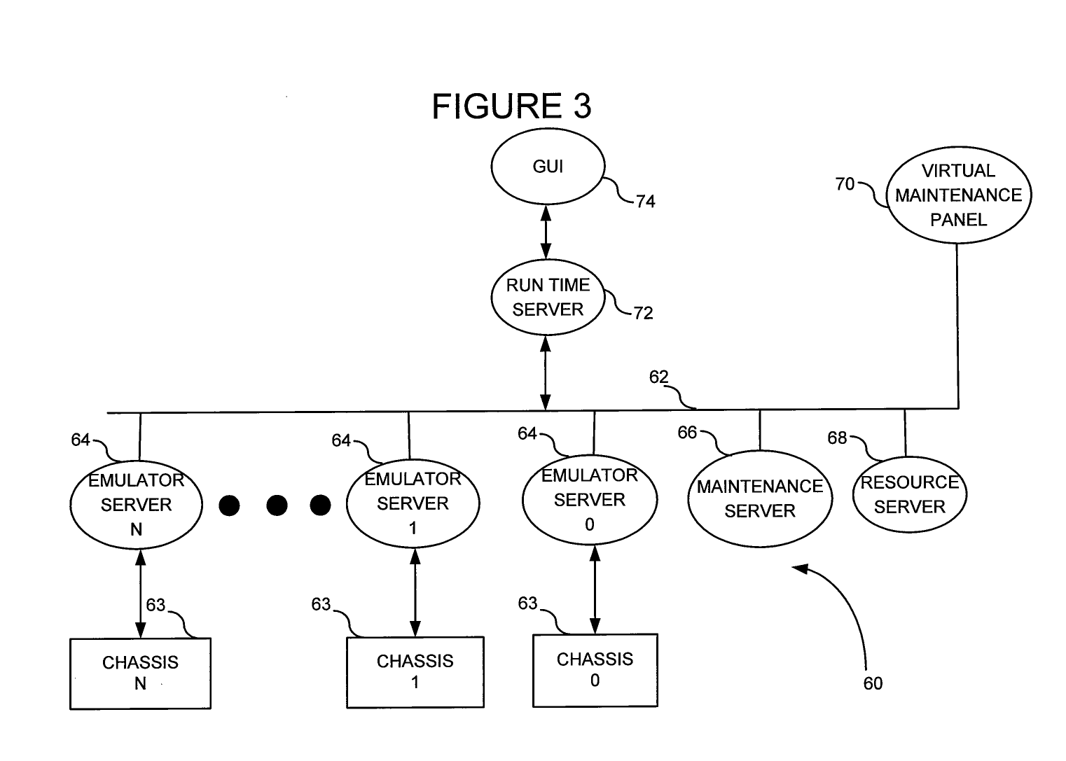

FIG. 3 shows a view of an embodiment of the emulator system including various servers 60 that, in this embodiment, communicate with one another, such as through a messaging bus 62. The emulator of FIG. 1 is to a single chassis emulator, while FIG. 3 is to a multiple chassis emulator (the word “multiple” meaning two or more), with the chassis of FIG. 1 repeated. Emulator servers 64 can be in charge of managing a physical host connection to the emulator and can provide a way to transfer data between the emulator messaging bus 62 and the emulator 12. In this embodiment, the emulator 12 includes multiple chassis, shown generally at 63. Each chassis can be a separate box having multiple slots in which printed circuit boards are mounted, such as any of the printed circuit boards described in FIG. 1. Any number of emulator servers 64 can be added. In one specific example there can be one emulator server for each chassis. Thus, there can be a one-to-one correspondence between emulation servers and chassis with each chassis being associated with a representative one of the emulation servers. As a result, any number of chassis can be added to the system by adding on a corresponding number of emulator servers depending on the number of designs or size of the design being emulated. The maintenance server 66 can be in charge of diagnostics, and storing maintenance information collected from other applications, servers, and/or emulator boards. The maintenance server can also interact with a GUI 74 to display the information to the user. The resource server 68 can be in charge of managing the different emulator resources provided to the applications. A virtual maintenance panel (VMP) 70, in this example, can be the main user interface through which the user can control the system, monitor and control the emulators 64. A run-time server 72 can receive instructions through the GUI 74 and can interact with the emulator servers 64 to receive data from the emulator servers and provide control information to the emulator servers.

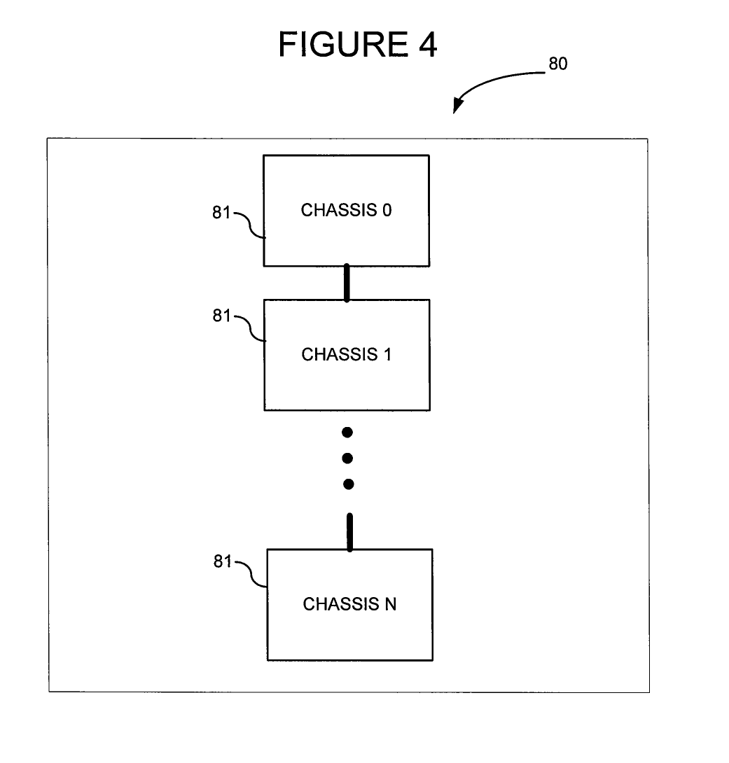

FIG. 4 shows an embodiment of a user interface 80. A user can select among various chassis 63 by clicking on one or more of the representations 81 of the chassis. Through the user interface 80, the user can power on the desired chassis 63 to activate the chassis and/or view further information about the chassis, such as how many PCBs are loaded into the chassis, where the PCBs are located, which ICs are faulty on the PCBs, etc.

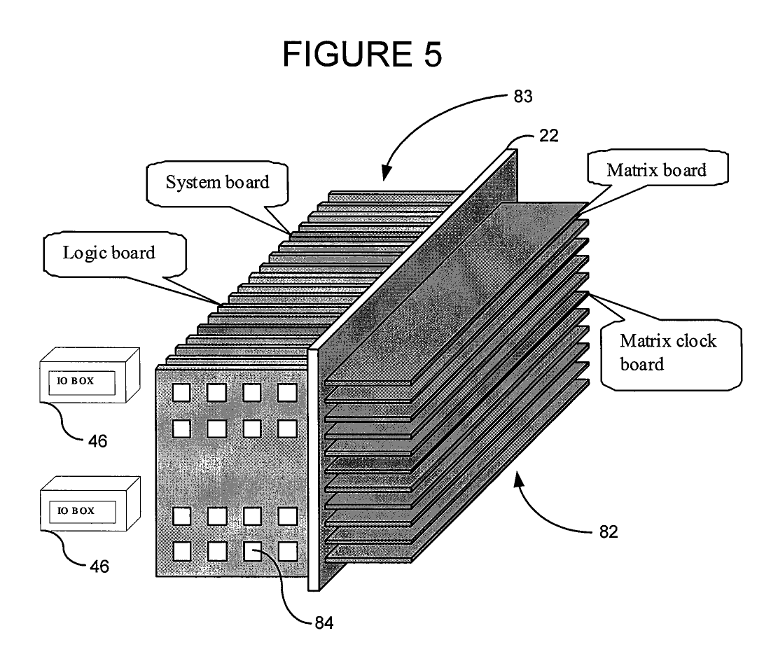

FIG. 5 shows an embodiment of a physical three-dimensional view of a single emulator chassis, which corresponds to the emulator portion 18 including the midplane 22 having horizontal boards 82 coupled to one side of the midplane, and vertical boards 83 coupled to the opposite side of the midplane. The physical integrated circuits are shown at 84. The IO boxes 46 can sit separately and are not generally considered part of the emulator.

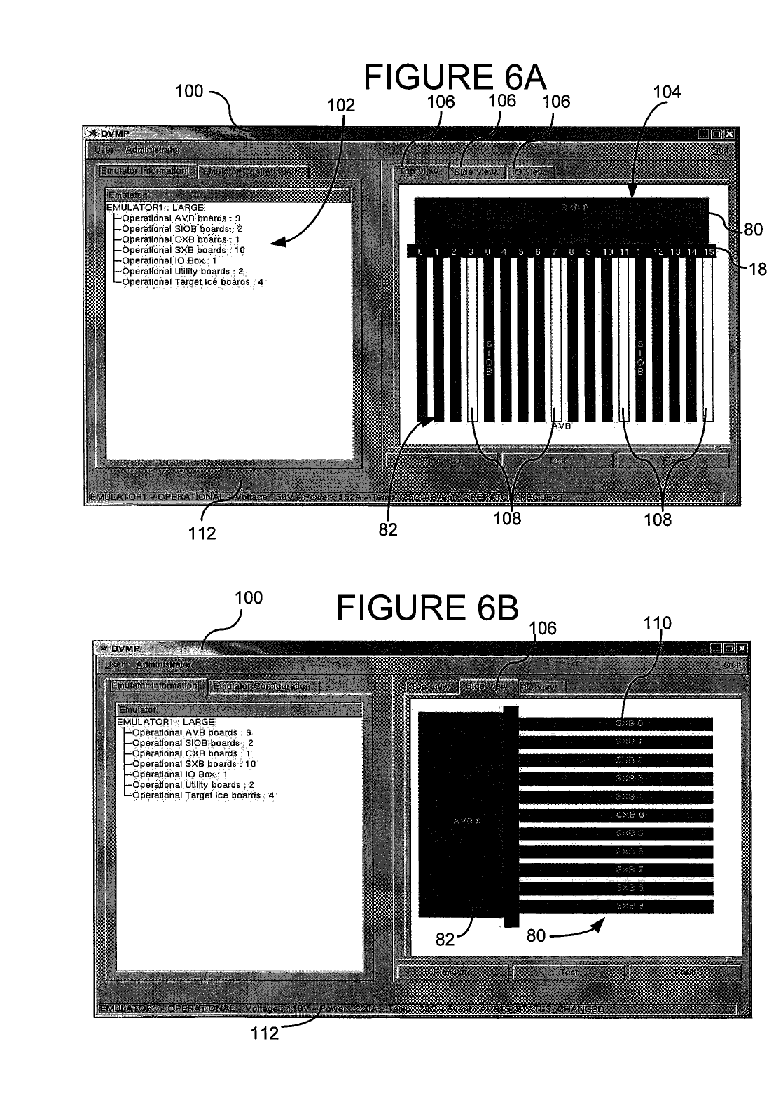

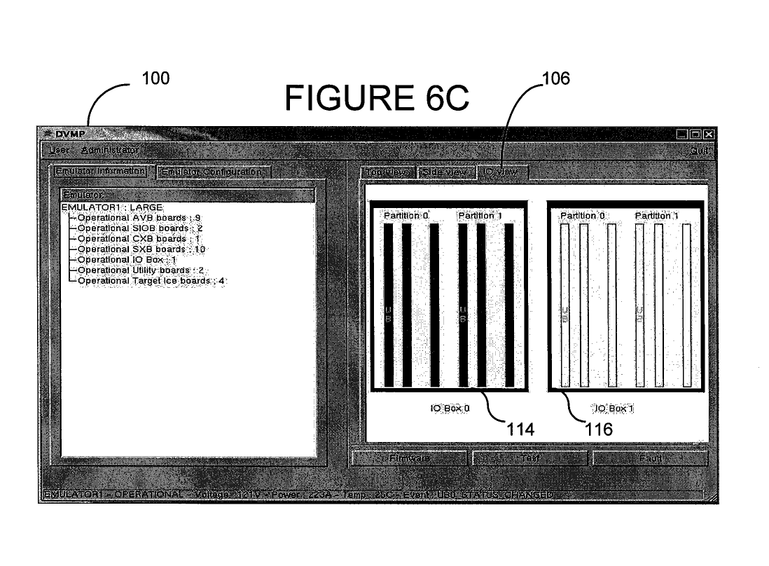

FIG. 6A shows an embodiment of a window 100 of the GUI displayed on any of the computers 14 or accessible from the computers 14. The window 100 can have an emulation information panel 102 and a physical system view panel 104. The emulation information panel 102 can provide a summary of the number of boards in the system that are operational and provides the board types. For example, the panel 102 lists that nine AVB boards are operational and one CXB board is available in one of the chassis. AVB is a board type that includes programmable FPGAs, VLSI, or ICs used for programming the user's design (see FIG. 1 at 24) whereas the CXB board is a board that generates the system clocks (see FIG. 1 at 28). Other boards are also listed, such as the SXB boards (switching matrices)(see FIG. 1 at 30), the SIOB boards (I/O board interface)(see FIG. 1 at 26) and the IO boxes 46. In panel 104, three tabs 106 provide different physical views of the system, including a top view, side view and IO view. The top view tab is selected in FIG. 6A and shows a physical view of the boards of FIG. 5. Only the top-most board of the horizontal boards 82 can be seen, while all of the vertical boards 83 are shown. The midplane 22 is shown having numbers 0-15 representing each available AVB slot for the vertical boards 83, plus 0-1 representing SIOB slots for the vertical boards 83. The darkened slots represent the boards physically positioned in the slots, while the white boxes, shown at 108, represent empty slots. The physically present boards can also be shown in different colors (not shown) to represent whether the board is correctly operating or has a malfunction.

FIG. 6B shows an embodiment of the same window 100 with the side view tab 106 selected. In this view, the physical boards of the system shown in FIG. 5 are seen from the side view. In this case, only one vertical board 83 in slot 0 is visible, while the horizontal boards 82 are displayed including indicia 110 to indicate the board type.

Thus, from FIGS. 6A and 6B, the physical view of the system is shown including board types, their slot positions within the system, and whether or not they are properly functioning. Additionally, both views provide a status line 112 that provides real time physical parameters associated with the system, such as the emulator name (shown as an alpha-numeric string), whether that emulator is operational, the voltage, power, temperature, and the last change in the physical environment that occurred.

FIG. 6C shows an embodiment of the same window 100 with the IO view tab 106 selected. This view shows two IO boxes 114 and 116. IO box 114 is currently shown as operational with six boards plugged in, while IO box 116 is shown having empty slots.

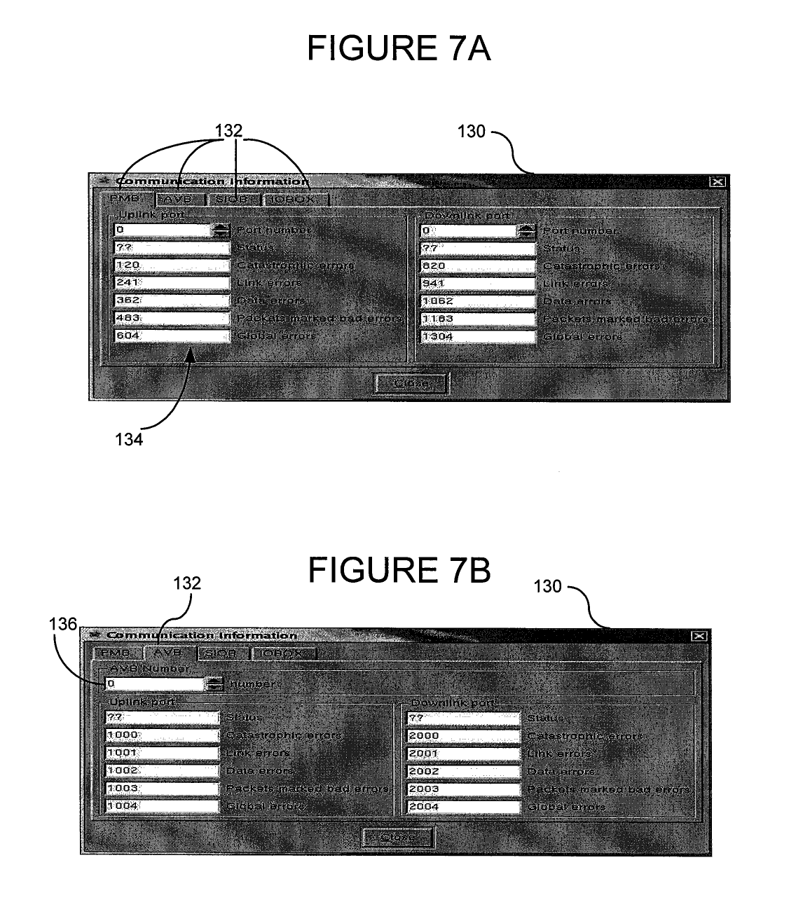

FIGS. 7A and 7B show an embodiment of different views related to communication information in a window view 130. Tabs 132 allow the user to select the board type within the system. For example, in FIG. 7A, the tab PMB can be selected and panel 134 can show different communication errors associated with the PMB 42. For example, catastrophic errors, link errors, data errors, packets marked bad errors and global errors. Thus, the physical error information is available for any board.

FIG. 7B shows an embodiment of the window view 130 with the AVB tab 132 selected. In this view, a drop down window 136 can be provided to allow the user to select which AVB board to view. Thus, for any desired AVB, the user can view real time or substantially real time error information. Tabs 132 also include views of other system boards, such as SIOB and the IO Boxes.

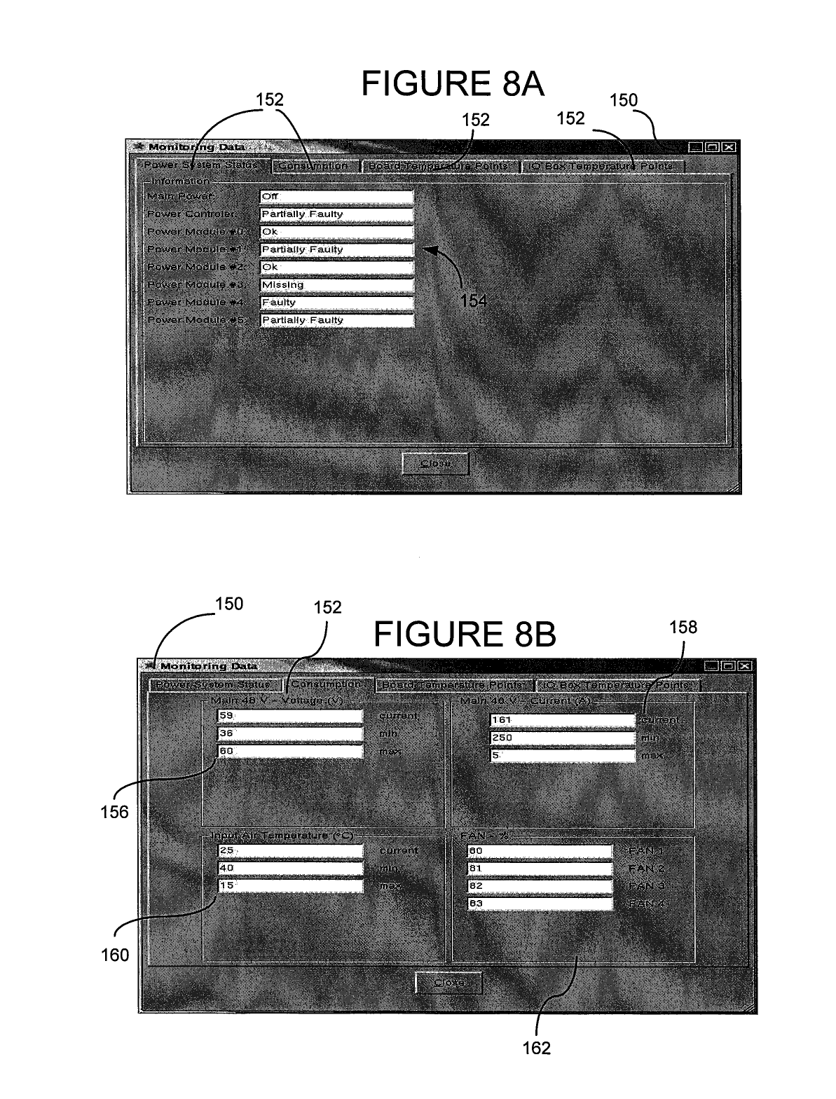

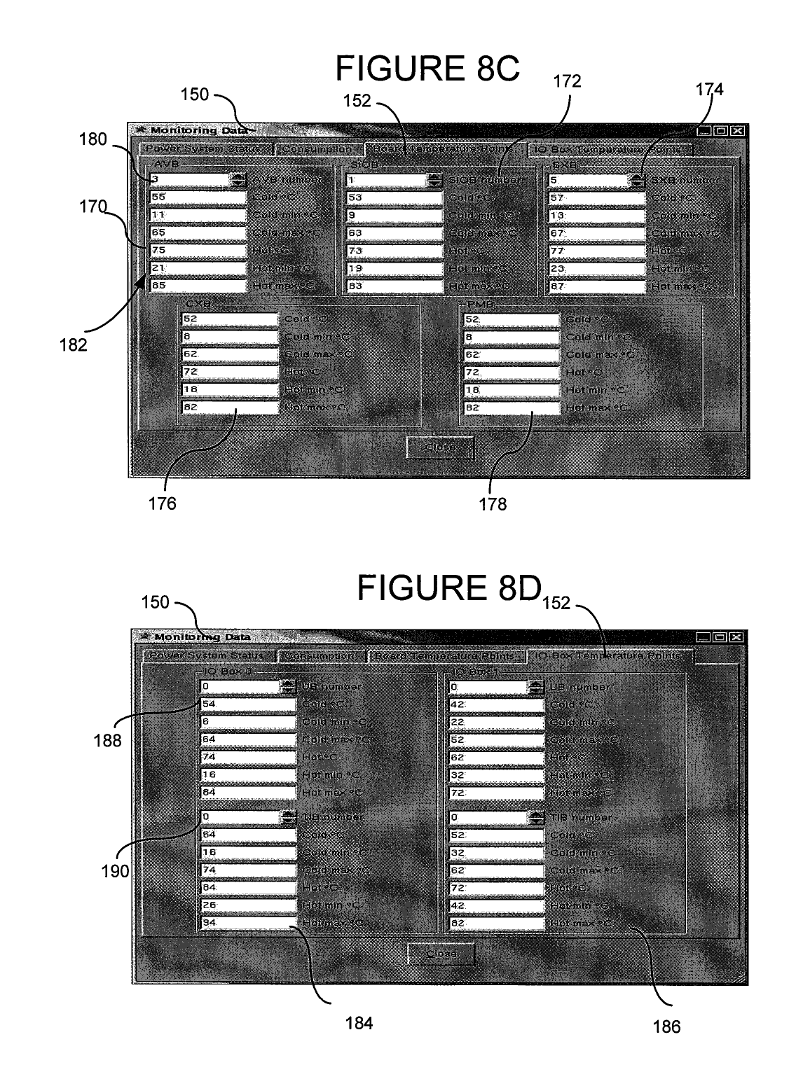

FIGS. 8A through 8D show an embodiment of a window 150 related to monitored data within the system. Thus, other physical parameters associated with the system can be viewed in the GUI in real time. In FIG. 7A, window 150 can have tabs 152 including a power status system tab, a consumption tab, a board temperature tab and an IO Box temperature tab. FIG. 8A shows the power status system tab selected and shows information windows 154 that indicate whether the main power is on or off, and the status of various power modules. Different status information shows that module is OK, missing, faulty, partially faulty, etc.

FIG. 8B shows an embodiment of the consumption tab 152 selected resulting in four panels 156, 158, 160, and 162 being displayed. Panel 156 shows the current voltage consumption and the minimum and maximum voltage consumption. Panel 158 shows the current being consumed and the minimum and maximum current levels used. Panel 160 shows the current air temperature within the emulator as well as the minimum and maximum air temperatures. Panel 162 shows the fans being used in the system and their current percentage of operational capacity. Thus, 80% means the fan can increase another 20% to be at maximum capacity, but increasing fan speed can increase noise and vibration within the system.

FIG. 8C shows an embodiment of the window 150 with the board temperature tab 152 selected. In this window view, five panels can be displayed 170, 172, 174, 176 and 178, each representing a different board type in the system. In panel 170, a drop down window 180 allows the user to select the particular AVB in the system. Currently, AVB number 3 is shown. Information windows 182 show the various temperatures of preselected points on the board. In this example, each AVB has a preselected hot point and a preselected cold point in which a temperature sensor is positioned. The information windows 182 show the current temperature at each of the hot and cold points as well as the minimum and maximum temperatures at each point. Each of the other panels, 172, 174, 176 and 178 can have similar functionality for the SIOB, SXB, CXB, and PMB, respectively.

FIG. 8D shows an embodiment of a window 150 with the IO Box temperature points tab 152 selected. In this case, two panes 184 and 186 are shown, each for its respective IO Box. In pane 184, drop down window 188 allows selection of different UB-type boards in the IO Box, while drop down window 190 allows different TIB-type boards to be selected. Once the desired boards are selected the current hot and cold point temperatures as well as the minimum and maximum temperatures are provided. Similar operation can be performed in pane 186.

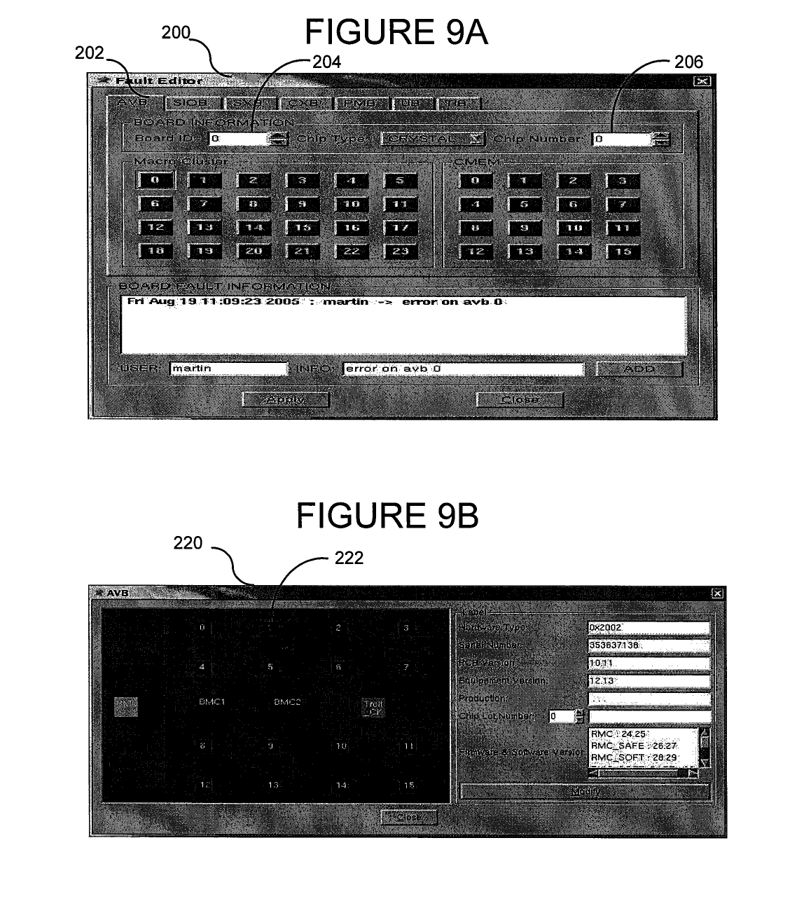

FIG. 9A shows an embodiment of further physical information associated with the boards within the emulator environment 10. In particular, FIG. 9A shows a fault editor window 200 that allows the user to visualize a cluster or memory within an IC to determine which areas of the IC have faults. Tabs 202 can allow the user to select the board type, and drop-down window 204 can allow the user to select the particular board within the system. Drop-down window 206 can allow the user to select the particular IC on the board to view whether the clusters and memory areas of the IC are functioning properly. Areas that are not functioning properly are indicated with a different color (not shown), such as red to indicate a problem area and green to indicate proper functionality.

FIG. 9B shows an embodiment of a window 220 with a physical view of a board in the system. The board view shows various ICs such as at 222. ICs that are not functioning properly are shown in a different color (not shown). In this way, a user can view physical parameters, such as the functionality of an IC, using the GUI and take corrective action if necessary.

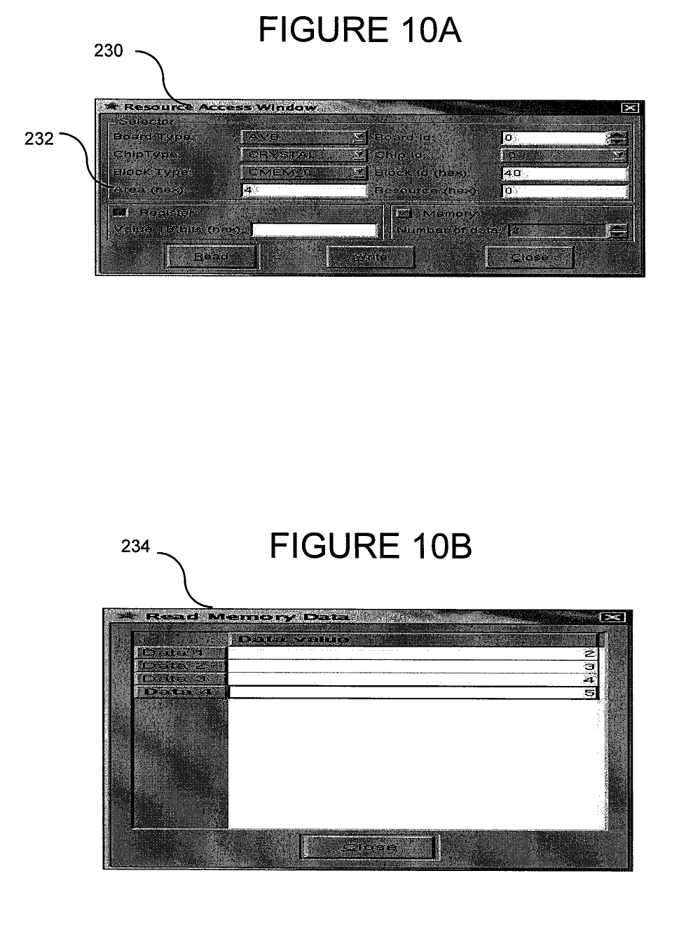

FIG. 10A includes an embodiment of a resource access window 230 that allows a user to access a particular register on a board in the system and modify the contents of that register using the GUI. For example, window 232 shows a particular register for the chosen board, chip, and block type. FIG. 10B shows a similar window 234 allowing the user to read and modify memory.

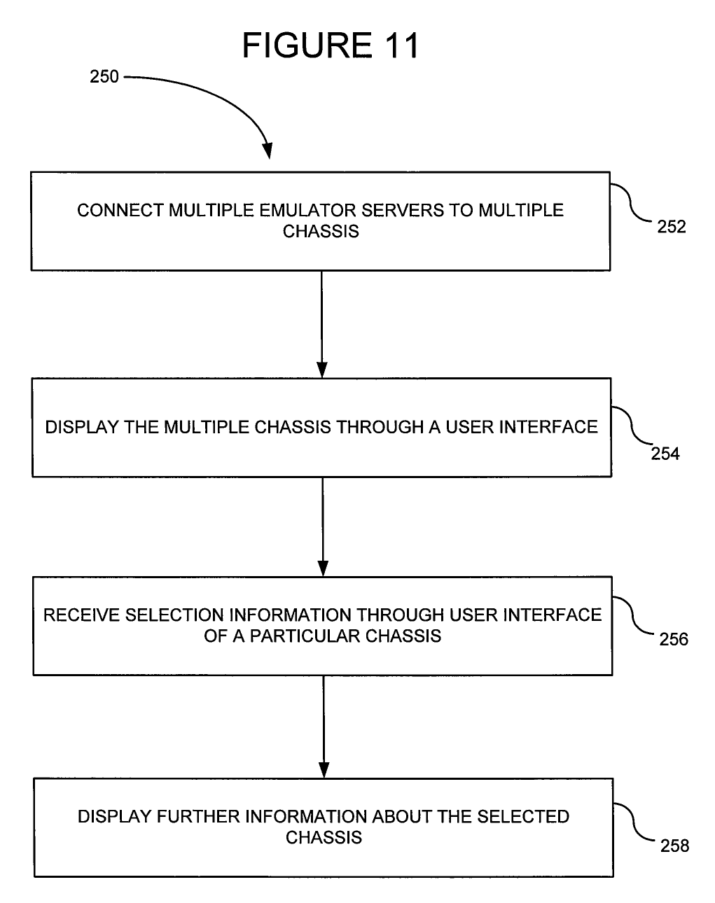

FIG. 11 shows a flowchart 250 of an embodiment of a method for displaying physical parameters within a graphical user interface (GUI). In process block 252, multiple emulator servers can be connected to multiple chassis. For example, each emulator server 64 can be connected to one chassis 63 as illustrated in FIG. 3. Allowing multiple servers to be connected to multiple chassis allows the emulator to be easily extended. In process block 254, multiple chassis can be viewed through the user interface, such as illustrated in FIG. 4. In process block 256, the emulator can receive selection information from a user through the user interface. For example, the user can select a desired chassis using the user interface of FIG. 4. In process block 258, in response to the user selection, further information about the chassis can be displayed, such as shown and described in FIGS. 6-10.

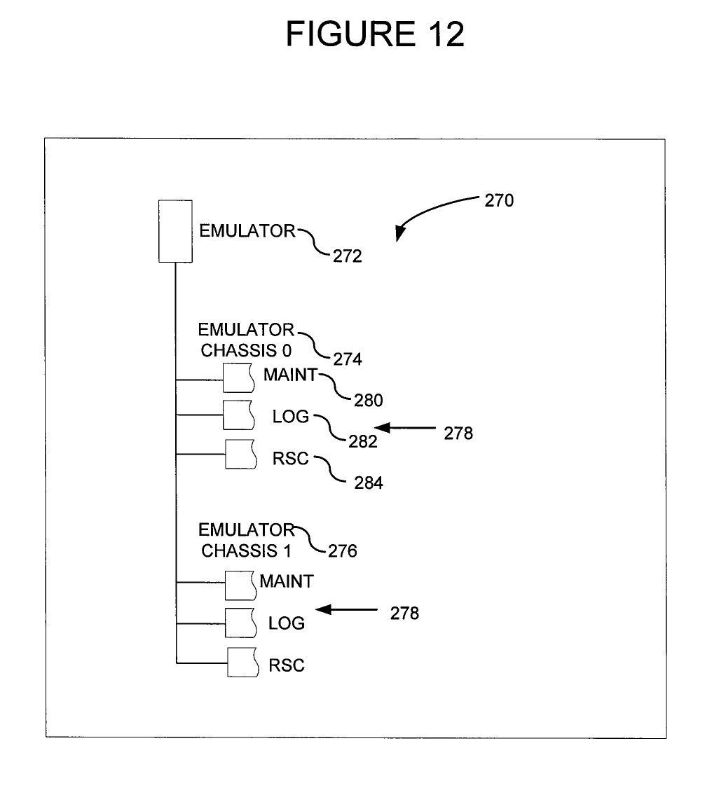

FIG. 12 is an illustration of an embodiment of a user interface 270 that can be displayed. In this embodiment, the user interface shows the emulator in a hierarchical view, such as a folder/file system. For example, a selected emulator is represented at 272 and is shown having two chassis 274, 276 associated therewith, which are designated chassis 0 and 1. Each chassis 274, 276 can have multiple folders associated therewith that are represented at 278. For example, a maintenance folder 280 can include maintenance information associated with the chassis, a log folder 282 can include logs of the emulation sessions, and the resource folder 284 can include resources associated with the chassis in the emulator. Chassis 1 can have a similar folder/file representation to chassis 0 and will not be further discussed. However, it is desirable to have a uniform folder/file system for each chassis for ease of navigation through the user interface. The particular folder/file structure may vary depending on the design.

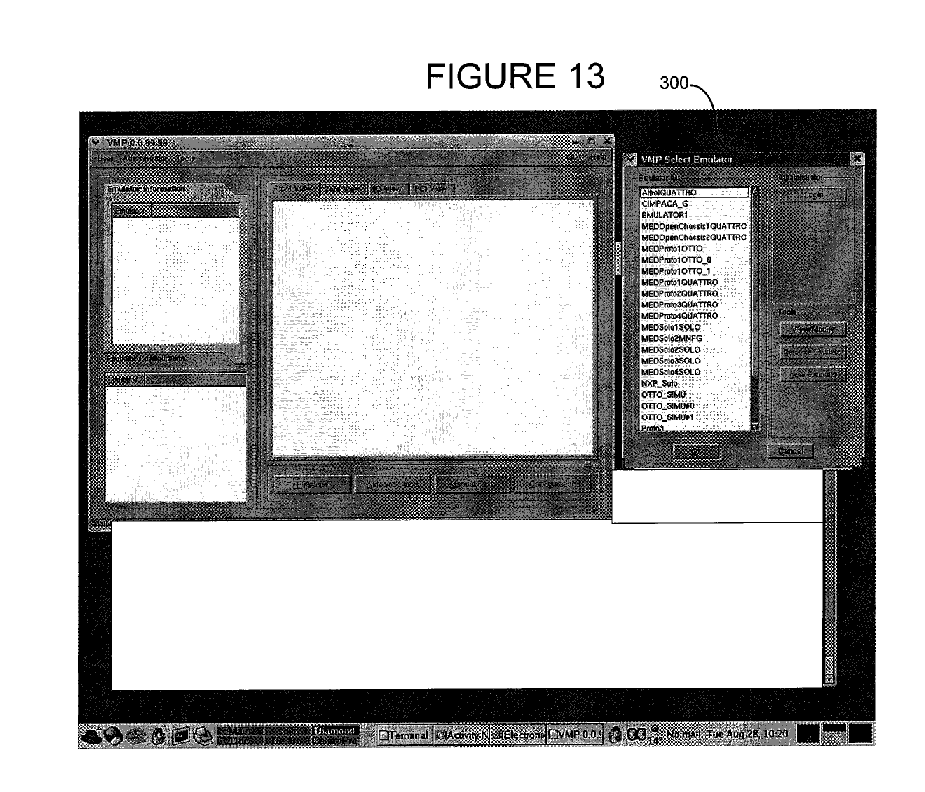

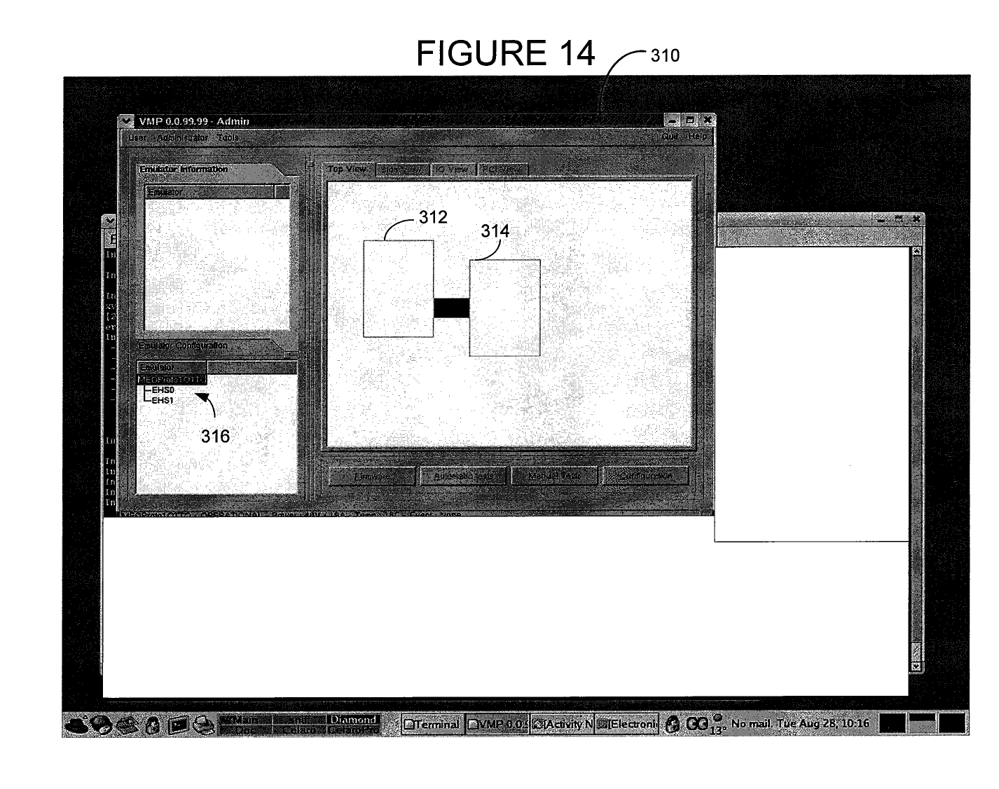

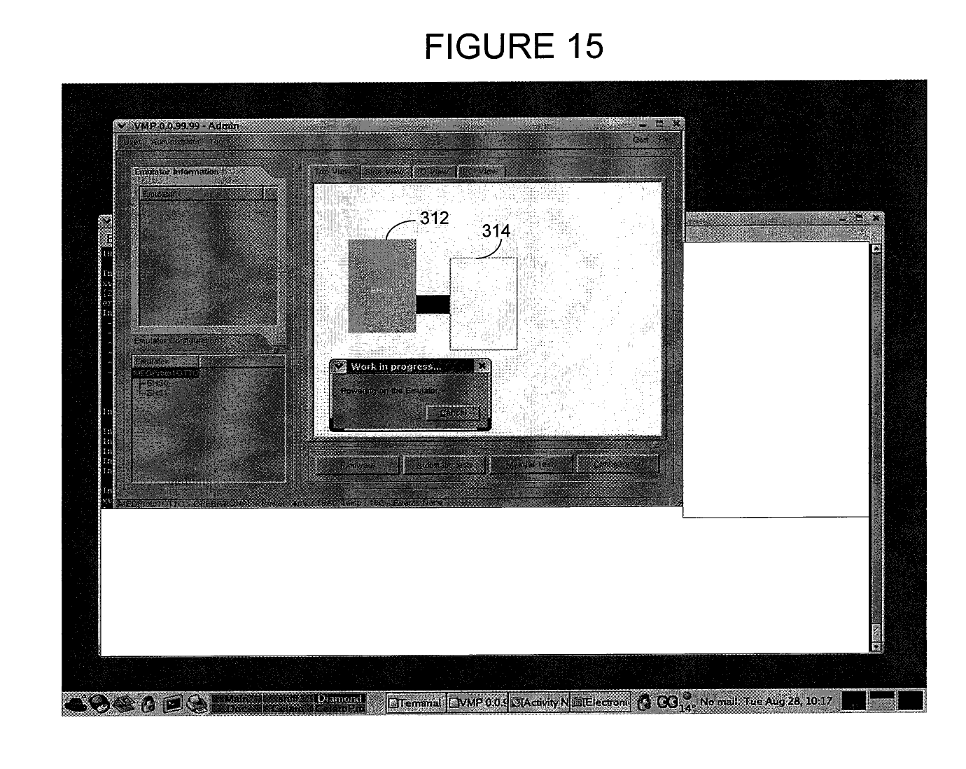

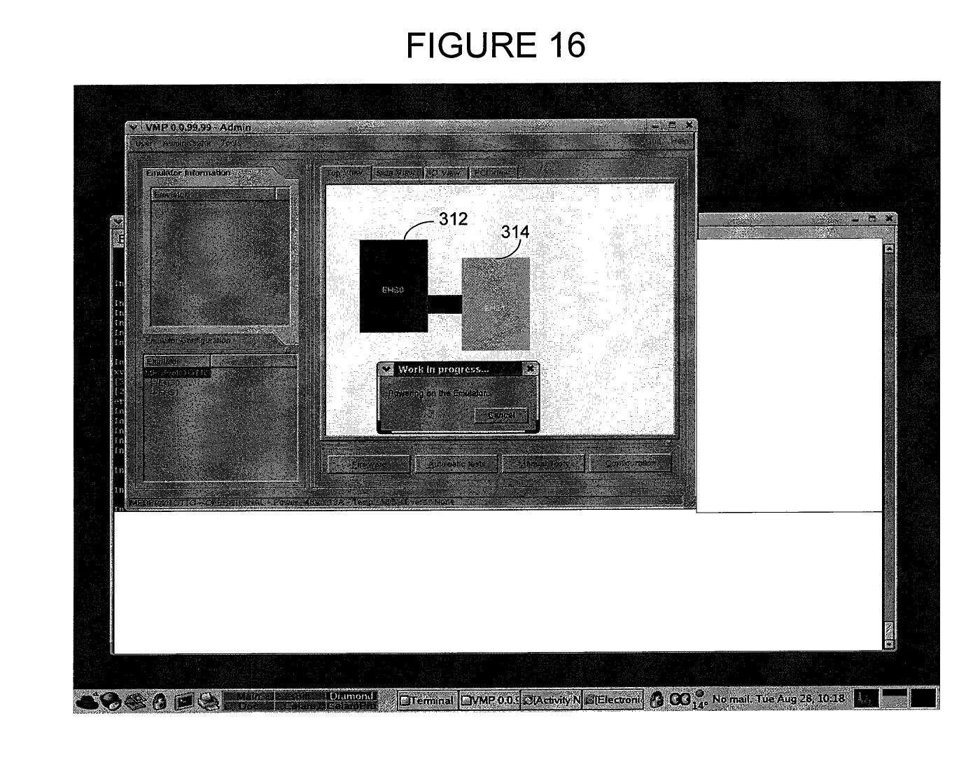

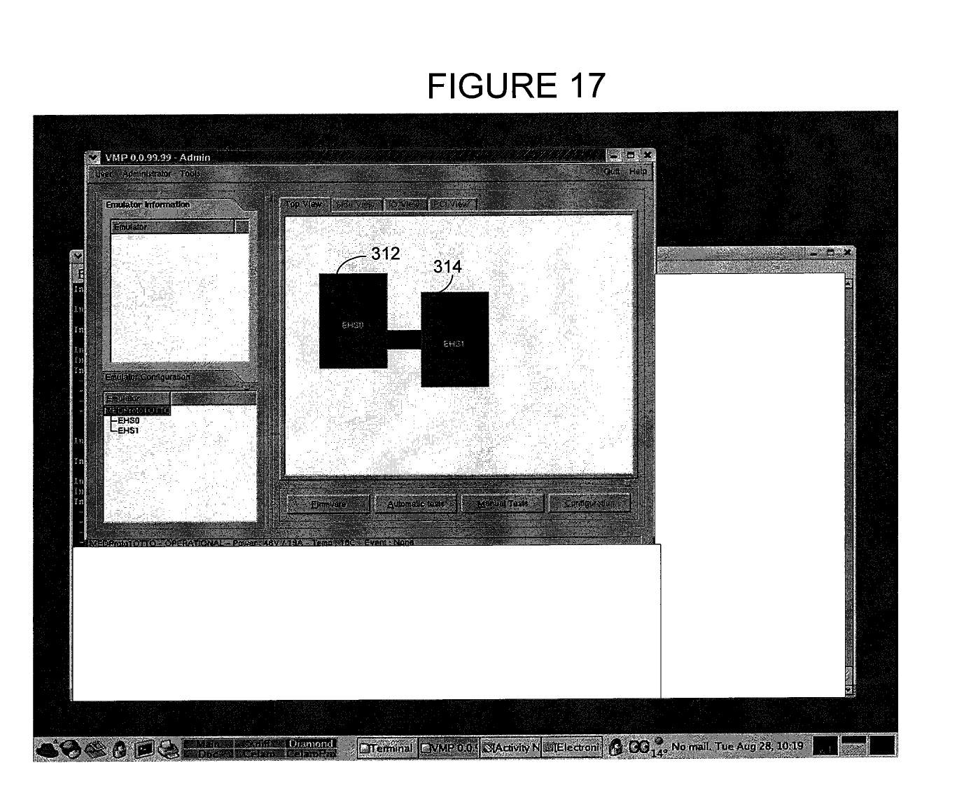

FIGS. 13-17 provide additional embodiments of a user interface. FIG. 13 shows an embodiment of a window view 300 including a list of emulators that can be selected by a user. Once an emulator is selected from the list, a window view 310 (FIG. 14) can be displayed showing particular chassis associated with the selected emulator. For example, chassis 312 and 314 can be displayed on the user interface. Additionally, a hierarchical view 316 can be presented to the user showing the various chassis. If any chassis in the hierarchical view 316 is selected, further details of the chassis can be illustrated in a folder/file structure as already described. FIG. 15 is an embodiment illustrating powering on a desired chassis in the selected emulator. The user may select chassis 312 in order to activate the chassis. Once the chassis is activated, it can be shown in a different color to highlight that it is active. FIG. 16 is an embodiment of the user interface showing chassis 314 after it is selected in order to activate the chassis. FIG. 17 is an embodiment showing both chassis 312, 314 selected and powered on and active.

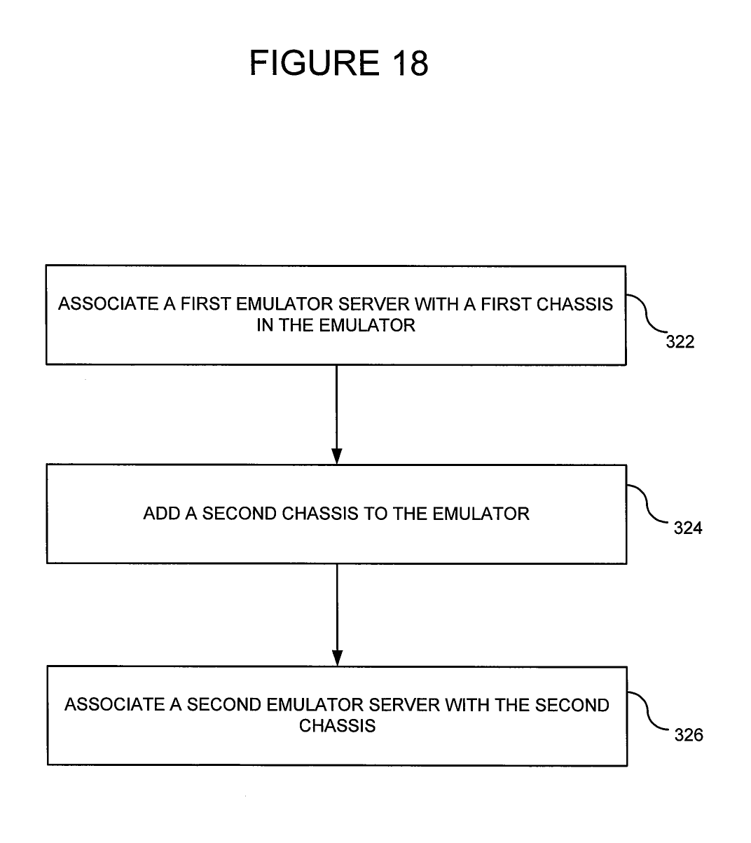

FIG. 18 is a flowchart of an embodiment of a method for connecting multiple chassis to the emulator. In process block 322, an emulator server is associated with a first chassis. In process block 324, a second chassis is added to the emulator. In process block 326, a second emulator server is added and associated to the second chassis.

Having illustrated and described the principles of the illustrated embodiments, it will be apparent to those skilled in the art that the embodiments can be modified in arrangement and detail without departing from such principles.

It should be recognized that the GUI application can run out of any workstation not just the host workstation.

In view of the many possible embodiments, it will be recognized that the illustrated embodiments include only examples of the invention and should not be taken as a limitation on the scope of the invention. Rather, the invention is defined by the following claims. We therefore claim as the invention all such embodiments that come within the scope of these claims.

We claim:

1. A method, comprising:
emulating an integrated circuit design in the hardware emulator, the hardware emulator including multiple chassis having printed circuit boards mounted therein, the printed circuit boards having programmable logic thereon for emulating the integrated circuit design;
receiving selection information regarding a chassis of interest in the hardware emulator; and
displaying information about the selected chassis associated with the emulator in a graphical user interface.

2. The method of claim 1, wherein receiving the selection information occurs concurrently during the emulation.

3. The method of claim 1, wherein each chassis is a separate enclosure physically separated from the other chassis.

4. The method of claim 1, wherein displaying information about the selected chassis includes displaying multiple folders and files within the folders, which are selectable by a user.

5. The method of claim 1, wherein displaying information includes displaying location information of printed circuit boards within the selected chassis.

6. The method of claim 1, wherein displaying information further includes providing an indication which printed circuit boards are functioning properly and which printed circuit boards are not functioning properly.

7. The method of claim 5, wherein the location information includes identifying which slots within the emulators the printed circuit boards are located and which slots are vacant.

8. The method of claim 1, further including selecting a printed circuit board within the emulator, requesting error information associated with the selected printed circuit board and displaying the error information in the graphical user interface.

9. The method of claim 1, further including receiving temperature information associated with the emulator and wherein displaying the information includes displaying the temperature information.

10. The method of claim 1, wherein a user selects the chassis of interest.

11. The method of claim 1, further including adding a chassis to the emulator and adding a corresponding emulator server coupled to the added chassis.

12. A hardware emulator, comprising:
multiple chassis, each chassis housing multiple printed circuit boards with programmable logic thereon;
multiple emulator servers coupled to the multiple chassis; and
a messaging bus coupling together the multiple emulator servers.

13. The hardware emulator of claim 12, wherein the hardware emulator includes an emulation portion and a monitoring portion, the monitoring portion including a platform maintenance board for obtaining the physical parameters from the emulation portion.

14. The hardware emulator of claim 12, further including a run-time server coupled to the multiple emulator servers.

15. The hardware emulator of claim 12, further including a user interface for displaying file and folder information relating to a selected one of the chassis.

16. An emulator, comprising:
means for displaying representations of multiple chassis associated with the emulator;
means for receiving selection information for selecting one of the multiple chassis; and
means for retrieving physical information associated with a chassis that is selected.

17. The emulator of claim 16, wherein the physical information includes one or more of the following: current information, voltage information, temperature information, PC board functionality, and PC board position.

18. A method, comprising:
displaying a list of multiple hardware emulators;
receiving selection information regarding a hardware emulator of interest;
in response to the selection information, displaying multiple chassis associated with the selected hardware emulator;
receiving selection information regarding one of the displayed multiple chassis of interest;
displaying information about the selected chassis associated with the emulator in a graphical user interface.

19. The method of claim 18, further including activating the chassis in response to the selection information received about a chassis of interest.

20. The method of claim 18, wherein the displaying of information about a selected chassis includes a hierarchical display of folders and files.

21. The method of claim 18, wherein the displaying of information about a selected chassis includes displaying physical boards within the chassis.

22. The method of claim 18, further including providing multiple emulator servers coupled to the multiple chassis in a one-to-one correspondence.

23. A hardware emulator, comprising:
multiple chassis, each chassis housing multiple printed circuit boards with programmable logic thereon;
multiple emulator servers coupled to the multiple chassis;
a messaging bus coupling together the multiple emulator servers;
a run-time server coupled to the multiple emulator servers;
a user interface for displaying file and folder information relating to a selected one of the chassis; and
wherein the hardware emulator includes an emulation portion and a monitoring portion, the monitoring portion including a platform maintenance board for obtaining the physical parameters from the emulation portion associated with the selected one of the chassis.
